(19) United States
(12) Patent Application Publication
(10) Pub. No.: US 2006/0294596 A1
(43) Pub. Date: Dec. 28, 2006

(54) Methods, systems, and apparatus to detect unauthorized resource accesses

(76) Inventors: Priya Govindarajan, Hillsboro, OR (US); Priya Rajagopal, Worcester, MA (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/167,939

(22) Filed: Jun. 27, 2005

(51) Int. Cl. H04L 9/32; H04N 7/16; G06F 17/30; G06F 7/04; G06K 9/00; H03M 1/68; H04K 1/00; H04L 9/00

(52) U.S. Cl. 726/27; 726/28; 726/29

(57) ABSTRACT

A tamper-proof access monitor monitors accesses by software executing on a host processor to memory-mapped regions of memory that control input/output resources.

### BACKGROUND

The inventive subject matter pertains to accesses to resources and, more particularly, to methods, systems, and apparatus to detect unauthorized accesses to resources.

“Malware” is defined herein to mean malicious software. Due to malware, critical computer systems and communication systems resources may become compromised. Examples of malware may include computer viruses, worms and Trojan horses. Such malware is specifically designed to damage or disrupt critical system resources.

### BRIEF DESCRIPTION OF THE DRAWINGS

FIG. 1 is a block diagram of a resource access system and apparatus in accordance with various embodiments of the present invention.

FIG. 2 is a flow chart of a method for detecting unauthorized resource access in accordance with various embodiments of the present invention.

### DETAILED DESCRIPTION

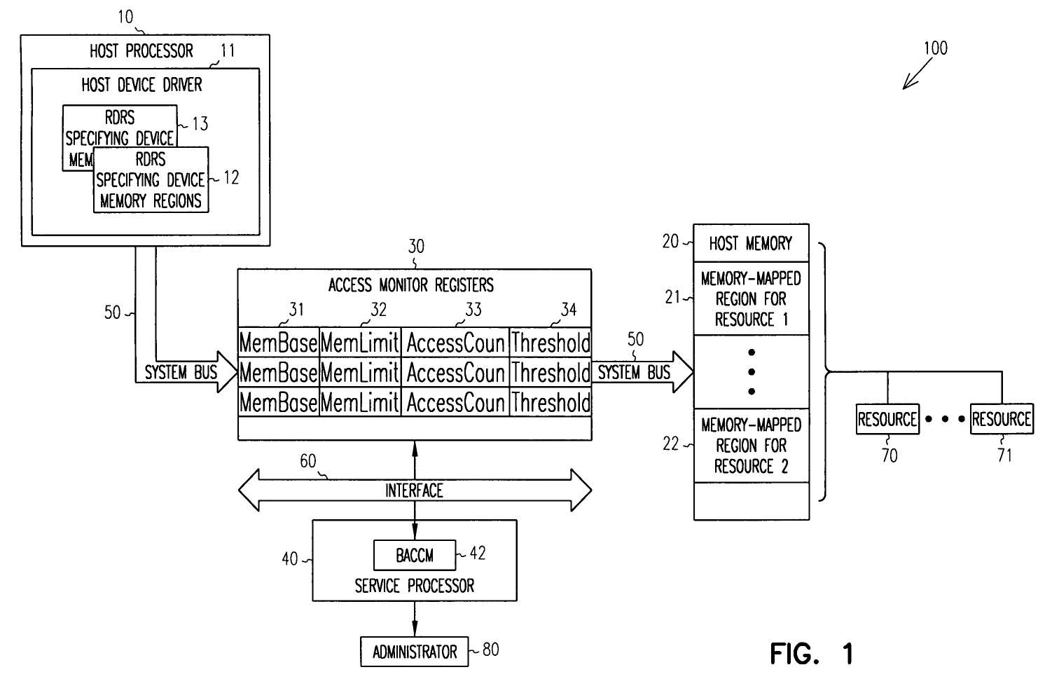

FIG. 1 is a block diagram of a resource access system and apparatus 100 in accordance with various embodiments of the present invention. Host processor 10 is coupled to host memory 20 via access monitor registers 30. System bus 50 couples host processor 10 to host memory 20. Service processor 40 is coupled to access monitor registers 30 via interface 60. Host memory 20 is coupled to and controls operation of resources 70 and 71. Resources may include a host processor's 10 hard drive. Service processor 40 is coupled to system administrator 80. Service processor 40 may be a tamper resistant environment isolated from host processor 10, a virtual partition or a separate processor.

Host processor 10 may include device driver 11 which may include a number of resource data records (RDRs) 12 and 13. These RDRs 12 and 13 include resource-specific information. Among other things, the RDRs have access information to the host memory 20, which control resources 70-71 in a memory-mapped input/output (I/O) configuration as shown in FIG. 1. In host memory 20 memory-mapped regions 21 and 22 store control and status information pertaining to resources 70 and 71, respectively. There need not be a one-to-one relationship between a memory region and a resource. For example, a resource, such as an interface card, may include a memory configuration region, a memory-mapped region and an I/O region.

Host processor 10 is coupled to access monitor registers 30 (also referred to herein as access monitor 30) via the system bus 50. As the device driver 11 is attempting to write to host memory 20 to control one of the resources 70-71, the write operation passes through access monitor registers 30. Each column of registers 31-34 in the access monitor registers may correspond to one memory-mapped region 21 and a corresponding resource 70.

Each row of registers may have a memory base address register 31, a memory limit register 32 and an access count register 33. Further, each set of registers may optionally have a threshold register 34. Memory base address register 31 stores the start of memory-mapped region 21, for example. Memory limit register 32 stores the size or length of memory-mapped region 21, for example. Access count register 33 stores a running count of the number of accesses made to memory-mapped region 21, for example. In addition, the access count register 33 may be a rate count register including a number of accesses per unit of time.

Optionally, threshold register 34 may store a threshold access number for detecting excessive resource accesses by software executing on the host processor 10. The contents of the threshold register 34 may be a mean or a number of standard deviations, for example. The thresholds being a mean or a standard deviation may alleviate any polling by the service processor 40 because the access monitor registers 30 can trigger an access count register 33 overflow to service processor 40.

Also, if available, the access monitor registers 30 may store an identity of the host driver 11 that is executing on the host processor 10 making the access to whichever resource. An example identification may include a source address that is making the memory access.

Access monitor registers 30 may be implemented on a chip-set, in an embodiment. In other embodiments, access monitor registers 30 may be formed on a motherboard as one or more chips. In virtual environments, the chip or chip-set may be implemented as a virtual machine monitor that controls accesses input from virtual machines. However, the implementation is not limited to these configurations. A “chip” is a semiconductor device. A “semiconductor device” may be fabricated by various technologies known to those of ordinary skill in the art such as silicon, gallium arsenate, etc.

Access monitor registers 30 are not accessible by the host processor 10 in some embodiments. Further, in other embodiments, access monitor registers 30 may be read-only to prevent tampering. A separate physical device implementation (separate chip or chips), such as mentioned above, prevents tampering with the parameters stored in the registers 31-34 by computer worms or viruses executing on the host processor 10.

If allowable by the access monitor registers 30, the attempted resource access by the host processor 10 is transmitted to the appropriate memory-mapped region 21-22 of host memory 20.

Service processor 40 may be coupled to access monitor registers 30 via an interface 60. Service processor 40 may include one or more behavioral access control capability modules (BACCM) 42. The service processor 40 may configure the access monitor registers 30. The BACCM 42 may poll or query the access monitor registers 30 to determine the status information, such as the access count 33 or the threshold 34, for example.

The information in the access monitor registers 30 may include such information as the identity of the application software that has accessed a resource and a count of the number of accesses, for example. From such access information a profile may be built by the BACCM 42.

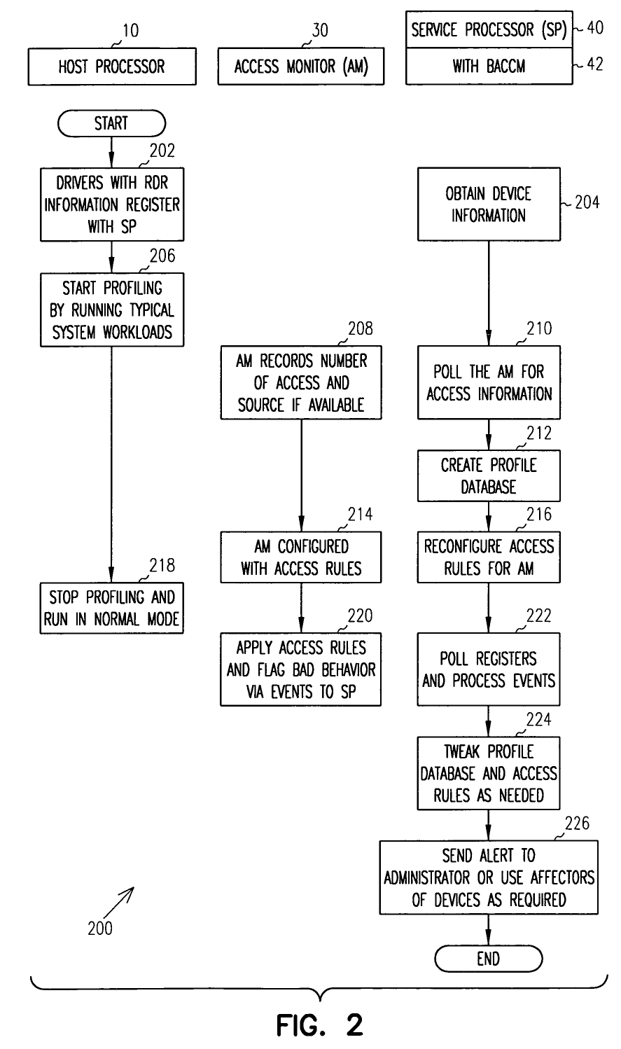

FIG. 2 is a flow chart of a method 200 for detecting unauthorized resource access in accordance with various embodiments of the present invention. Containing certain elements depicted in FIG. 1 and previously described regarding FIG. 1, FIG. 2 depicts the interactions of a host processor 10, access monitor registers 30 and a service processor 40 having a behavioral access control capability module (BACCM) 42. Time moves from top to bottom in FIG. 2, and the different components (10, 30, 40 and 42) may work concurrently. For example, while the profiling software runs on the host processor 10, the access monitor registers 30 record the accesses, and the BACCM 42 of the service processor 40 polls the access monitor registers 30 and creates the profile database.

At the top of FIG. 2, the method of FIG. 2 is started, and block 202 is entered. Each device driver 11 registers with the BACCM 42 of service processor 40, block 202. As a result of the device driver 11 registering with BACCM 42, BACCM 42 obtains device information, such as physical locations of the memory-mapped location 21 (start address and length) corresponding to a resource 70, any critical data structures, and the identity of which register set is serving a particular resource 70, block 204.

The host processor 10 begins to profile, block 206, the access count by executing, in a test mode, non-production mode or baseline mode, system traffic resulting in resource access requests. The profiling may include simulated bench marking applications, workloads, conducted in a baseline mode, and/or test workloads conducted in an on-line/maintenance mode. The system 100 may be temporarily removed from service in a brief test mode, non-production mode or baseline mode. The profiling executes on the host processor 10 until terminated or until completed. The system 100 is then restored to a normal on-line operation mode, block 218.

While the profiling operation is executing block 206, the access monitor 30 records in access count register 33 the number of accesses to each of the resources 70-71, block 208. The source of the access request may optionally be recorded in the access monitor 30, if space is available. Then the BACCM 42 polls the access monitor 30 for the access count in the access count register 33 corresponding to each of the memory-mapped regions 21-22 and resources 70-71, block 210.

The BACCM 42 then creates a profile database within the service processor 40, block 212. The BACCM 42 may analyze the raw data and determine whether it is sufficient as a measure of the typical access counts. The BACCM 42 may substitute mean or standard deviation data for the actually collected raw data, if it so decides.

Next the access monitor 30 is configured with suitable access rules obtained from the raw data as a result of the profiling operation, block 214. If the BACCM 42 decides to replace the access rules of the access monitor 30 with a mean or a standard deviation data, for example, the BACCM 42 will re-configure the access rules of the access monitor 30, block 216.

Next, the system 100 is returned to the normal operation mode by host processor 10, block 218. The access monitor 30 monitors memory accesses requests for resources 70-71 in a normal operation mode. If there is a threshold register 34, the access monitor 30 then applies the latest set of rules, block 220, so that, when the threshold is met or exceeded, a mismatch occurs and the access monitor 30 may send an alert or alarm to BACCM 42.

Alternatively, the BACCM 42 can periodically poll the access monitor 30 and analyze the data of the access count register 33 to determine whether the number of accesses exceeds a certain value as mentioned above, block 222. This does not imply that it is simply necessary to exceed the value. A significant deviation in the access count or access rate from that which was profiled may indicate a host driver 11 problem also.

The BACCM 42 may decide that a slight adjustment of the threshold register 34 is appropriate and adjust the database and access rules or threshold as it determines, block 224.

Further, if a violation of the rules is detected, for example too many accesses to memory, then the BACCM 42 may take other actions. As a first action, the BACCM 42 can request that the host processor 10 unload the current executing software. As a second action, the BACCM 42 can, in addition, send an alert to the system administrator 80, block 226. In some embodiments, service processor 40 and BACCM 42 are coupled to system administrator 80 via an out-of-band (OOB) secure management channel.

As a third action, the BACCM 42 can cause all network communications by the system 100 to be disabled, if the service processor 40 has such ability.

Further, if the identity of software executing on host processor 10 that caused the violation of the access rules can be determined, then the BACCM 42 can cause a restricted access to the resources 70-71 and corresponding memory-mapped regions 21-22 by the suspect software.

Embodiments of the invention may be implemented in one or a combination of hardware, firmware and software. Embodiments of the invention may also be implemented as instructions stored on a machine-readable medium, which may be read and executed by at least one processor to perform the operations described herein. A machine-readable medium may include any mechanism for storing or transmitting information in a form readable by a machine (e.g., a computer). For example, a machine-readable medium may include read-only memory (ROM), random-access memory (RAM), magnetic disk storage media, optical storage media, flash-memory devices, electrical, optical, acoustical or other form of propagated signals (e.g., carrier waves, infrared signals, digital signals, etc.), and others.

The operations described herein are just exemplary. It should be noted that the individual activities shown in the flow diagrams do not have to be performed in the order illustrated or in any particular order. Moreover, various activities described with respect to the methods identified herein can be executed in serial or parallel fashion. Some activities may be repeated indefinitely, and others may occur only once. Various embodiments may have more or fewer activities than those illustrated.

It will be understood that although “Start” and “End” blocks are shown, the method may be performed continuously.

The Abstract is provided to comply with 37 C.F.R. §1.72(b) requiring an Abstract that will allow the reader to ascertain the nature of the technical disclosure. It is submitted with the understanding that it will not be used to interpret or limit the scope or meaning of the claims.

In the foregoing Detailed Description, various features are occasionally grouped together in a single embodiment for the purpose of streamlining the disclosure. This method of disclosure is not to be interpreted as reflecting an intention that the claimed embodiments of the subject matter require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. Individual claims may encompass multiple embodiments of the inventive subject matter.

Although some embodiments of the invention have been illustrated, and those forms described in detail, it will be readily apparent to those skilled in the art that various modifications may be made therein without departing from the spirit of these embodiments or from the scope of the appended claims.

What is claimed is:

1. An apparatus comprising:
a host processor to communicate with a resource;
an access monitor coupled to the host processor and to the resource; and
a service processor coupled to the access monitor to monitor access to and control access to the resource by the host processor.

2. The apparatus as claimed in claim 1, wherein there is further included a memory coupled to the access monitor and to the resource, the memory to provide a memory-mapped interface between the host processor and the resource.

3. The apparatus as claimed in claim 2, the service processor including a behavioral access control module to monitor and to control the access monitor.

4. The apparatus as claimed in claim 3, the host processor including an element to store at least one resource data record including data describing a memory area corresponding to the resource.

5. The apparatus as claimed in claim 4, the at least one resource data record including a plurality of resource data records corresponding to a plurality of memory areas and to a plurality of resources

6. The apparatus as claimed in claim 5, the access monitor including a plurality of registers corresponding to each of the plurality of memory areas.

7. The apparatus as claimed in claim 6, the plurality of registers corresponding to each memory area including:
a base address register;
a size register; and
an access count register.

8. The apparatus as claimed in claim 7, the plurality of registers corresponding to each memory area further including a threshold register.

9. The apparatus as claimed in claim 6, the plurality of registers being collectively formed on a semiconductor chip or semiconductor chip set.

10. The apparatus as claimed in claim 2, wherein there is further included a system bus coupled between the host processor and the access monitor and between the memory and the access monitor.

11. The apparatus as claimed in claim 1, wherein there is further included an interface to couple the service processor to the access monitor.

12. The apparatus as claimed in claim 1, the service processor being coupled to an administrator, and wherein, responsive to the access monitor detecting an unauthorized access request, the service processor is to communicate the unauthorized access to the administrator.

13. A system comprising:
at least one resource;
a host processor to communicate with the at least one resource via a memory;
an access monitor coupled to the host processor and to the memory; and
a service processor coupled to the access monitor to detect an unauthorized access to the memory by the host processor.

14. The system as claimed in claim 13, the access monitor including a plurality of registers corresponding to each of a plurality of memory areas and to a plurality of resources, the plurality of registers including:
a base address register;
a size register;
an access count register; and
a threshold register.

15. The system as claimed in claim 13, wherein there is further included an administrator coupled to the service processor to receive notification of the unauthorized access.

16. A method comprising:
obtaining access information by an access monitor related to a host processor accessing a memory to control a resource;
determining from the access information when the host processor's access to control the resource violates an access rule; and
when the access rule is violated, sending an alert to a system administrator.

17. The method of claim 16, where there is further included profiling by the host processor baseline mode accesses by the host processor to the resource.

18. The method of claim 17, wherein there is further included recording the access information by the access monitor.

19. The method of claim 18, wherein there is further included:
polling the access monitor by a service processor to obtain the access information for the profiling operation;
creating by the service processor a profiling database responsive to the profiling operation; and
configuring by a behavioral access control module of the service processor access rules for normal operation mode accesses by the host processor to the resource.

20. The method of claim 19, wherein there is further included:
ending the profiling operation by the host processor; and
configuring the access monitor and the service processor to a normal operation mode.

21. The method of claim 20, wherein there is further included recording by the access monitor the access information in the normal operation mode.

22. The method of claim 21, wherein there is further included applying by the access monitor the access rules for normal operation mode accesses by the host processor to the resource.

23. The method of claim 22, wherein there is further included polling by the behavioral access control module the access monitor for the normal operation mode.

24. The method of claim 23, wherein there is further included:
adjusting the profiling database responsive to the access information for the normal operation mode; and
modifying the access rules responsive to the adjusting operation.

25. The method of claim 24, wherein there is further included disabling the resource responsive to a normal operation mode access violating the access rules.

26. The method of claim 25, wherein there is further included transmitting resource-specific information by a device driver to the behavioral access control module.

27. The method of claim 26, wherein there is further included configuring by the behavioral access control module the access monitor with the resource-specific information.

28. A machine-accessible medium having associated instructions, wherein the instructions, when accessed, result in a machine performing:
recording access information by an access monitor related to a host processor accessing a resource in a normal operating mode;
comparing by a behavioral access control module the recorded access information with stored access information; and
when the recorded access information and the stored access information mismatch, disabling the resource from normal operating mode access by the host processor.

29. The machine-accessible medium of claim 28, wherein there is further included periodically monitoring by the behavioral access control module the recorded access information.

30. The machine-accessible medium of claim 29, wherein there is further included periodically profiling by a service processor normal operating mode accesses by the host processor to the resource to produce the stored access information.
